(19) United States
(12) Patent Application Publication
(10) Pub. No.: US 2007/0271715 A1
(43) Pub. Date: Nov. 29, 2007

(54) Spray-wipe shoe sole cleaning apparatus and method of use

(76) Inventor: Don Scoralle, Fountain Valley, CA (US)

Correspondence Address: PATENT LAW & VENTURE GROUP, 2424 S.E. BRISTOL, SUITE 300, NEWPORT BEACH, CA, 92660, US

(21) Appl. No.: 11/441,403

(22) Filed: May 24, 2006

(51) Int. Cl. B08B 1/00

(52) U.S. Cl. 15/104.92

(57) ABSTRACT

A cleaning apparatus for shoe soles has a resilient base mat and a top mat of a moisture absorbent fabric. A reservoir contains a cleaning solution and a foot actuated spray mechanism and a foot actuated lever delivers a fine spray of the solution to one portion of the top mat. Shoe soles are wiped on the wetted surface of the top mat and then the shoes are dried by wiping the soles on a dry portion of the mat.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to door mats and similar apparatus for cleaning the soles of shoes and more particularly to a spray and wipe apparatus and method of use for improved cleaning of shoes prior to walking on clean floors.

2. Description of Related Art Including Information Disclosed Under 37 CFR 1.97 and 1.98

Tai, U.S. Des 362148, discloses a design for a doormat. Stull, U.S. Des 401100, discloses a design for a mat. Kafka et al., U.S. Des 478452, discloses a design for a protective non-slip mat. Coppa, U.S. 2004/0078909, discloses a disinfecting mat that enables better cleaning of shoes. The mat has three discrete sections, with each section carrying out a different function in cleaning the shoes. A first section has a laterally extending bristle brush for cleaning material from the shoes while the second section includes a reservoir containing a liquid disinfectant that is transferred to the shoe of the user by an endless belt that dips into the reservoir and carries the disinfectant to the upper surface of the belt to be transferred to the shoes. Finally, in a third section there is a stationary wiping mat to enable the user to brush the shoes across the mat to rid the shoe of remaining material as well as dry the shoe from the liquid disinfectant. All of the sections are convenient to the user and housed within a unitary molded base. Sevenich, U.S. Pat. No. 2,953,805, discloses a self-contained portable shoe cleaner and dryer having a low silhouette for use in cleaning and drying the shoes of a user stepping thereon comprising a relatively large platform having a small vertical dimension, a housing mounted at one end of the platform, the housing having a greater vertical dimension than the vertical dimension of the platform, an air heating and blower assembly mounted within the housing, the platform being covered with a water and wear resistant fabric, the platform and the fabric having a plurality of aligned vertical apertures therein, a pair of cleaning pad portions mounted on and positioned adjacent the ends of the platform, an intermediate cleaning pad mounted on the platform and positioned between the pair of cleaning pad portions, the cleaning pad portions and the intermediate cleaning pad having appreciable vertical dimensions and defining vertically extending edges for use in cleaning the shoes on the platform, a plurality of horizontally directing ports along the vertically extending edges, the air heating and blower assembly having a discharge nozzle, and means interconnecting the discharge nozzle with the apertures and the ports whereby streams of heated air are forced upwardly through the apertures and horizontally through the ports for enveloping and drying the shoes on the platform. Burns, U.S. Pat. No. 4,918,779, discloses an improved foot spraying and cleaning device which includes a pair of opposed facing brushes, each of which has embedded therein an elongated bar having a plurality of fluid outlets therein, with the outlets of the respective bars facing one another. Flow of fluid through the bars is controlled by a foot-actuated valve mechanism. Aesthetic housings may be provided for the brushes which may be made to resemble shells. Alazet, U.S. Pat. No. 5,071,628, discloses a device that provides a reception surface for shoe soles to be disinfected, beneath which is an element impregnated with a disinfection liquid, the complete assembly being contained in a shallow tray or reservoir which is placed on the ground or embedded in this latter. The tray or reservoir contains a certain quantity of disinfection liquid and above the level of this liquid is a rigid plate which bears on the bottom of the tray or reservoir, for example by means of spacer members or ribs. The impregnation element consists of a sheet of porous material stretched over and supported by the rigid plate. At least one of the edges of the sheet dips into the disinfection liquid contained in the tray or reservoir and serves as a capillary wick to impregnate the sheet with disinfectant. A perforated covering element covers the impregnation sheet so as to constitute the receiving surface for the shoes to be disinfected. Strickler et al., U.S. Pat. No. 5,164,164, discloses a self actuating sole wetting device for use in treating the soles of shoes, feet, paws and the like with a wetting solution selected for a particular hygienic purpose. The device includes a sole receiving subassembly and a peripheral structure subassembly forming a tray, and a reservoir subassembly for delivering the solution to the tray. Absorbent pad members allow wetting uneven surfaces and prevent splashing. Flow control on the reservoir prevents excessive depth and splashing. The sole wetting device is particularly adapted for use with animals such as dogs or in canine environments, to prevent the spread of parvo and other diseases. Rotoli, U.S. Pat. No. 5,297,309, discloses a device for disinfecting parts of persons, animals and objects passing over it and coming into contact with it and the ground, especially the soles of shoes, includes a doormat provided with a rectangular aperture; a shallow flat-bottomed rectangular tray having a bottom and vertical sides made from metal and shaped to form a channel having a C-shaped transverse cross-section opening outwards, the flat-bottomed tray being dimensioned so that the tray can fit in the aperture with edge portions of the door mat engaged in the channel; a sheet of rectangular spongy material which fits in the shallow flat-bottomed rectangular tray; a portion of a disinfecting liquid impregnating the sheet of spongy material; and an elastic grating resting freely on the sheet of spongy material and having an elasticity so that, when depressed by the parts of the persons, animals and objects the grating flexes sufficiently to compress the sheet of the spongy material sufficiently to force disinfecting liquid residing in the spongy material through the elastic grating to the parts to be cleaned and/or disinfected. Bleth, U.S. Pat. No. 5,964,959, discloses a shoe cleaning device using liquid sprays and including a housing with a base portion and two side portions. The side portions are spaced from each other and extend upwardly from the base portion to form a U-shaped opening through the housing. In the preferred embodiment, rollers support the user's shoe as it is moved through the housing. Crisscrossing, upwardly directed sprays then strike and clean the shoe bottom while downwardly directed side sprays clean the shoe sides. Any portions of the upwardly directed, crisscrossing sprays not striking the user's shoe are captured in the opposing side portions and directed into the base portion. In this manner, the bottoms and sides of the user's shoes can be effectively cleaned without getting the user's leg or the tops of the shoes wet. Pruitt, U.S. Pat. No. 5,996,160, discloses an entry mat for placement before an entry door to permit cleaning of shoe soles. The entry mat has a liquid reservoir with an open top, and a plurality of adjacent parallel generally cylindrical brushes mounted such that certain bristles thereof extend outwardly from the open top of the liquid reservoir for engagement of a shoe bottom and certain bristles thereof extend inwardly into the reservoir. At least one of the cylindrical brushes is rotatable. The mat has a liquid absorbing fabric material releasably retained in a taut configuration by a stretcher, a wiping mat, and a frame member having respective compartments within which the liquid reservoir, liquid absorbing fabric material and wiping mat are housed. Use of the entry mat is a three step process wherein shoe soles are first wiped on the wiping mat to remove larger sized debris. Next, the shoe soles are subjected to the brushes whereby the at least one rotating brush introduces liquid from the reservoir to the soles for cleansing. Finally, the shoe soles are repeatedly rubbed on the taut liquid absorbing fabric material for drying. Blum, U.S. Pat. No. 6,219,876, discloses an improved floor mat. In an embodiment of the present invention, the floor mat that includes a cleanable portion. The floor mat may also include a water absorbing component, a cushioning component, customized graphics, a transparent cleanable portion, a tacky surface on the cleanable portion, an antibacterial composition, an antifungal composition, and a fragrance. Additionally, the cleanable portion may be erodible and may include a plurality of cleanable reusable layers. Staal, U.S. Pat. No. 6,258,435, discloses a disinfecting mat that includes a spongy core retaining a liquid disinfectant and a cover completely enclosing the core, where the cover has a top surface with an annular top edge and a top central mat portion that is liquid permeable. The core is contained in a water impermeable frame with a bottom and sides that contain the cover and with an inwardly extending annular lip that extends over at least a part of the annular top edge while leaving the top central mat portion open. The liquid permeable top central mat portion allows the disinfectant to puddle in areas of the top central mat portion that are depressed during use. Staal, U.S. Pat. No. 6,749,918, discloses a mat that provides for cleaning and disinfection of the soles of boots or shoes worn by humans, hooves of animals, and/or tires of automobiles or farm equipment. The mat includes a core which can retain a liquid, a permeable material surrounding the core, and a waterproof sleeve covering a bottom, sides, and part of a top of the core. When pressure is put on the mat, a depression is formed which bathes the depressing element in the liquid, while the waterproof sleeve prevents the liquid from overflowing. Blum et al., U.S. Pat. No. 6,886,209, discloses an advanced floor mat. In an embodiment of the present invention, the floor mat includes a cleanable portion. The floor mat may also include a water dissipation component, a water absorbing component, a cushioning component, customized graphics, a transparent cleanable portion, a tacky surface on the cleanable portion, an antibacterial composition, an antifungal composition, and a fragrance. The cleanable portion may be erodible and may include a plurality of cleanable reusable layers. If a tacky surface is included in the floor mat, an anti-slip feature may be associated with the tacky surface to help prevent slipping on a possibly wet tacky surface. Additionally, a sensor system may be included in the floor mat to assist a user in identifying when the floor mat may require cleaning. Dean, U.S. Pat. No. 6,886,210, discloses a floor mat system for placement directly near an entryway to permit the disinfecting and cleaning of shoe soles and all other surfaces contacting directly with the fibers of the mat. The floor mat system consists of a frame structure either mechanical or rubberized in construction. The top portion being of a carpet type fiber construction, with a hollow center portion and rubberized non-skid backing against the floor and sides. The hollow center portion of the system may be enclosed and a microbicidal component introduced to the carpet fiber portion in a capillary action. Alternatively, the microbicidal component may be contained in a separate enclosed package which is introduced to the carpet fiber portion through spray heads located on the enclosed package in a pressure action activated by weight on the top carpet layer. The floor mat system may also be integrated into other floor or carpet. The floor mat system may also include a moisture absorbing component, a cushioning component, customized graphics, anti-fingal composition, or a fragrance. Anti-slip features may be associated with the mat to prevent slipping. Additionally, a sensor may be included in the floor mat to assist a user in identifying when the floor mat system may require refill of the microbicidal component. Hori, WO96/31153, discloses bactericidal mats to be laid at the doorways of clean zones of biochemical plants, hospitals, and similar facilities. The mat is provided with a body containing an alkaline compound as a bactericide. The mat body may further contain a surfactant and a humectant comprising a water-stable deliquescent material. When the body contains these additions as crystalline substances in particulate form, it can be used wet by supplying water thereto after being laid at the doorway. The supplied water dissolves the alkaline substance in the body thus imparting a bactericidal effect thereto. The mat is produced by impregnating the mat body with an aqueous solution of the additives and drying the body to thereby deposit the additives within the body.

The related art described above discloses several shoe cleaning devices which may be sorted into categories. First, some of these devices are simply dry mats where shoes are wiped as with the common entry door mat. Referring to the above paragraph, Tai, Stull, Kafka et al., and WO9631193 represent mats of this type. Additionally, there are dry sticky mats that provide a surface that removes debris from the soles of shoes by adhesion. Next, there are liquid spray system exemplified by Burns and Bleth. Finally, there are wet mats that generally have a liquid material in all or a part of the mat and these are described in the other references above. However, the prior art does not appear to teach the present system which combines the effects of both dry mats and wet mats. In the present system, the mat is essentially dry, but a mist sprayer of a cleaning solution is positioned to one side so that each cleaning event is initiated with a foot pedal spray of the solution onto a portion of the dry mat whereupon the soles may be scrubbed by rubbing them on the wetted mat and then drying them in the same way on a dry section of the mat. Therefore, the present invention distinguishes over the prior art providing heretofore unknown advantages as described in the following summary.

### BRIEF SUMMARY OF THE INVENTION

This disclosure teaches certain benefits in construction and use which give rise to the objectives described below.

A cleaning apparatus for shoe soles has a resilient base mat preferably of a rubber material, and a top mat of a moisture absorbent fabric such as a common bath towel made of terry material. The base mat engaged the terry material by the use of hook type material. A reservoir to one side of the mats contains a cleaning solution and a foot actuated spray mechanism delivers a fine spray of the solution to one portion of the top mat. The Shoe soles are then cleaned by manually wiping them on the wetted surface of the top mat and then the shoes are dried by wiping them on a dry portion of the mat. The novelty of this invention is its simplicity and the placement of the spray source to one side of the mat and directing the spray to only one portion of the mat leaving another portion dry for drying the shoes. The use of a foot pedal that has a receiver for frictional engagement with the spray nozzle so that it cannot rotate but rather is forced to maintain its targeted direction of spray, is a further novelty. When a pressurized can is used, a cradle supports it at an appropriate angle without any engagement device and positions the can for engagement by the foot pedal.

A primary objective inherent in the above described apparatus and method of use is to provide advantages not taught by the prior art.

Another objective is to provide a simplified system capable of cleaning and drying the soles of shoes.

A further objective is to provide an economic system whereby common bath towels, conveniently laundered, are used to accumulate dirt removed from shoes.

A further objective is to provide an economic system whereby common tap water or soapy water is used to clean the soles of shoes.

A further objective is to provide such a system whereby any selected cleaning agent packaged in a pressurized spray can, can be used to clean the soles of shoes.

A further objective is to provide such a system whereby any selected cleaning solution can be used to clean the soles of shoes.

A still further objective is to provide such a system whereby only as much wetting as necessary is pumped onto the mat so that children, adults, lightly soiled and heavily soiled shoes are easily accommodated.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of one embodiment of the presently described apparatus showing the manner of spraying a mat of the invention;

FIG. 2 is an exploded view thereof showing the separate elements;

FIG. 3 is a partial side elevational view thereof showing foot actuation of a spray can delivering a mist spray onto a portion of the mat;

FIG. 4 is a partial side elevational view thereof showing wiping action of a shoe on the sprayed portion of the mat;

FIG. 5 is a partial side elevational view thereof showing wiping action of a shoe on a dry portion of the mat;

FIG. 6 is a perspective view of a second embodiment of the presently described apparatus showing the manner of spraying the mat of the invention;

FIG. 7 is a partial side elevational view thereof showing foot actuation of a spray pump delivering a mist spray onto a portion of the mat;

FIG. 8 is a partial side elevational view thereof showing wiping action of a shoe on the sprayed portion of the mat; and

FIG. 8 is a partial side elevational view thereof showing wiping action of a shoe on a dry portion of the mat.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

Described now in detail is a cleaning apparatus for shoe soles 5, the apparatus preferably including a resilient base mat 10 having a waft material 12 such as hook type material on a least a portion of the base mat 10, and a top mat 20 preferably of a moisture absorbent terry fabric. The top mat 20 is laid over the base mat and especially in contact with the waft material gripping surface 12 and is therefore mechanically engaged with it. However, the top mat 20 may be easily removed by pulling it away from the base mat 10 when it becomes necessary to replace it, as for instance for laundering it. A reservoir contains a cleaning solution 40 and is positioned at an edge 14 of the base mat 10. A foot actuated spray mechanism 50 is engaged with the reservoir, and the spray mechanism 50 and reservoir 30 are positioned above the mats 10 and 20 and at edge 14.

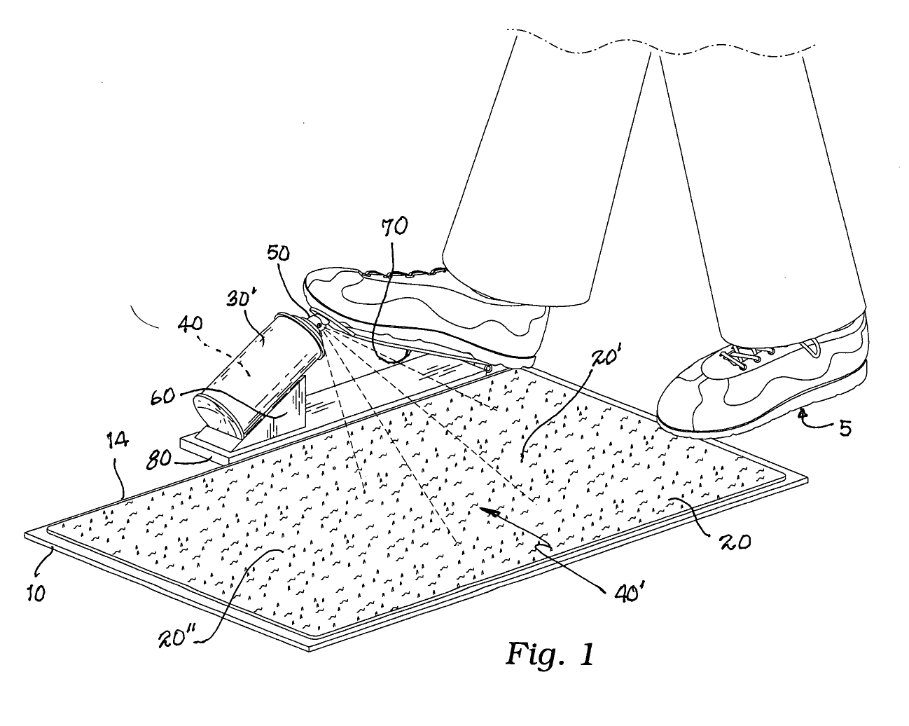

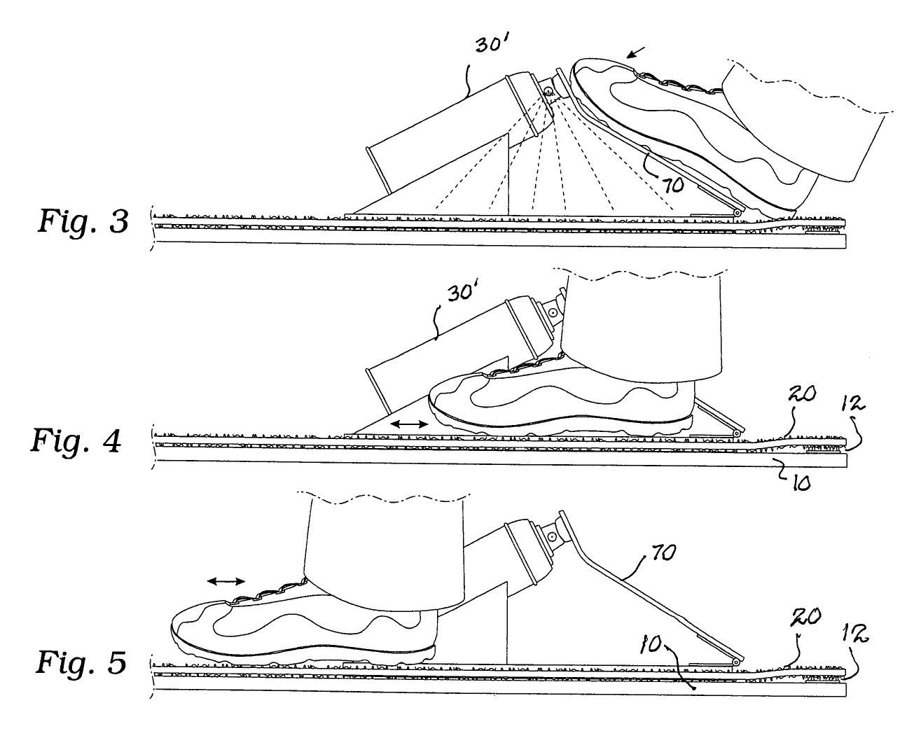

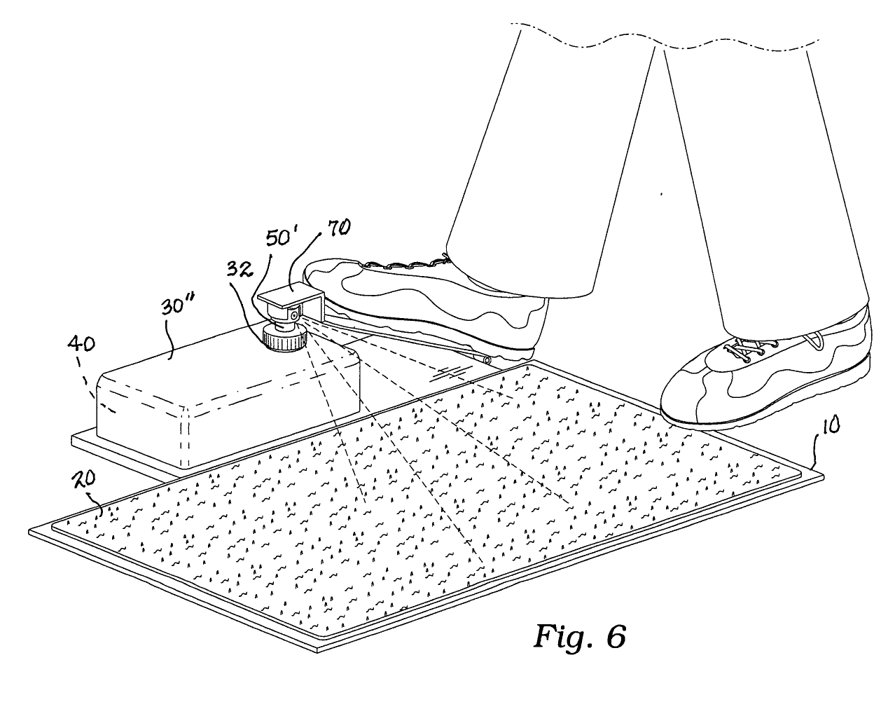

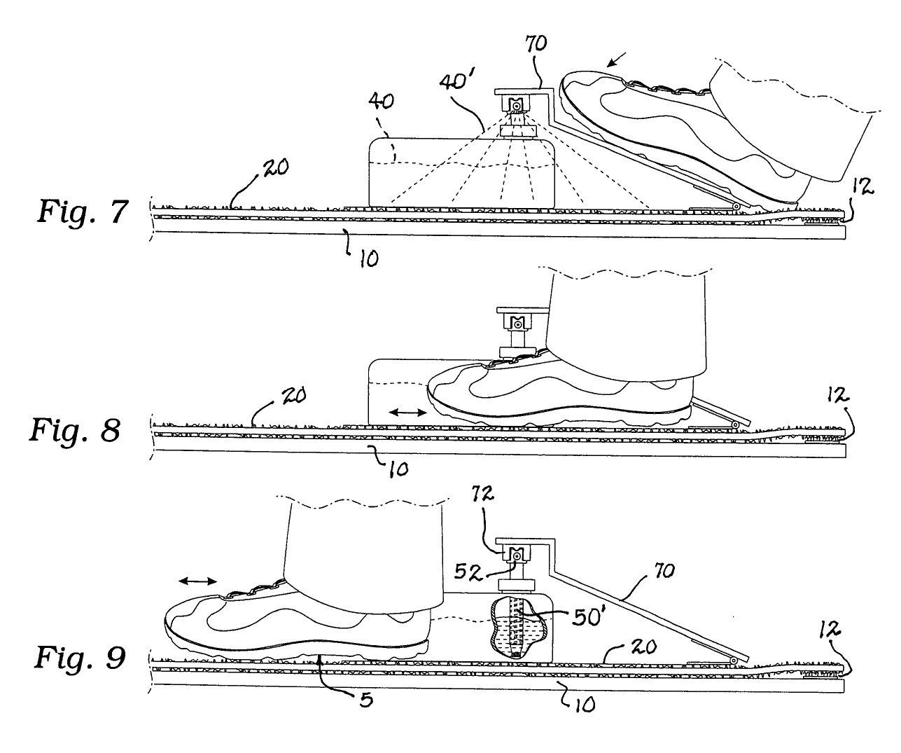

The spray mechanism 50 is enabled for drawing the solution 40 from the reservoir and disbursing a fine mist 40′ of the solution 40 onto a first portion 20′ of the top mat 20. A second portion 20″ of the top mat 20 is positioned so as to remain free of the fine mist 40′. To clean the shoe soles 5, the spray mechanism 50 is foot actuated as shown in FIGS. 1, 3, 6 and 7 so as to deliver the fine mist 40′ to the first portion 20′ of the top mat 20, and the shoe soles 5 are then dragged or wiped on the first portion 20′ of the top mat 20 to bring the solution 40 into rubbing contact with the shoe soles 5, as shown in FIGS. 4 and 8. The shoe soles 5 are then dragged or wiped on the second portion 20″ of the top mat 20 to dry the shoe soles 5 as shown in FIGS. 5 and 9.

In one embodiment of the present apparatus, the reservoir and spray mechanism 50 are jointly a pressurized spray can 30′ as shown in FIGS. 1-5. In a second embodiment of the present apparatus, the reservoir is a container 30″ providing an aperture 32 for accepting the cleaning solution 40 therein and the spray mechanism is a pressure actuated pump 50′ of the type well known in commercial bottles of spray cleaner.

Preferably, the cleaning solution 40 is any one of: water, a water ammonia solution, an aqueous solution containing an acid such as lemon juice, a soap solution, and a glass cleaner such as the commercial product trademarked Windex®. The solution 40 may be any formulation capable of wetting and cleaning the soles 5 of shoes.

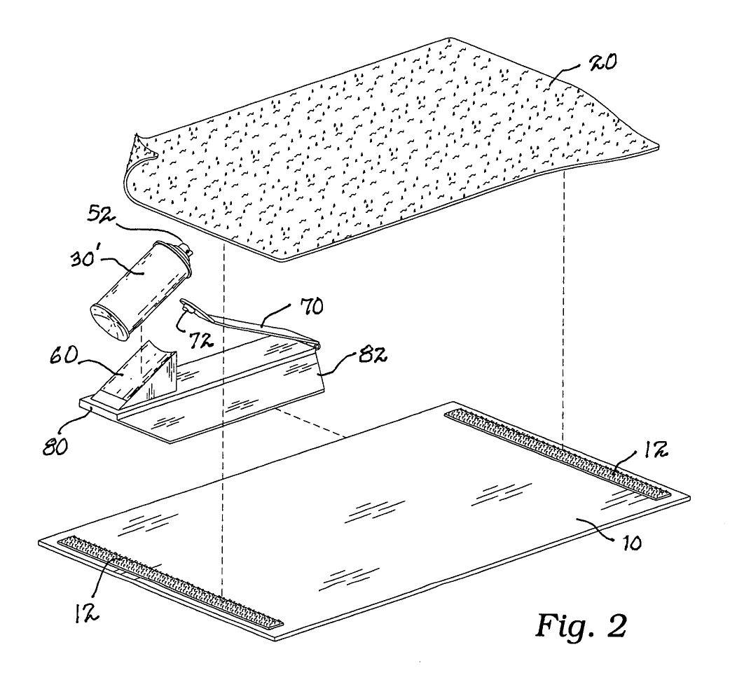

In the one embodiment wherein a pressurized spray can 30′ is used, the apparatus further comprises a stand providing a cradle 60 which supports the spray can 30′ as best shown in FIGS. 1 and 2. A hinged foot pedal 70 is engaged with a base plate 80, the base plate 80 further engaging the cradle 60. The base plate 80 is extensive for resting below the base mat 10 when the cradle 60 and the foot pedal 70 are positioned adjacent to the edge 14 of the base mat 10. The portion of the base plate 80 that is secured under the base mat 10 is shown in FIG. 2 as numeral 82 and base mat 10 is heavy enough to secure the base plate 80 so that it cannot move during use.

Preferably, the foot pedal 70 rests in contact with a spay cap 52 of the spray mechanism 50 so that when the foot pedal 70 is depressed, the spray cap 52 actuates the spray mechanism 50. Preferably, the foot pedal 70 engaged a spray cap receiver 72 which has a hollow conformation sized for frictionally gripping the spray cap 52 of the spray mechanism 50. This gripping function prevents the spray cap 52 from revolving so that once adjusted as to the angle of spray desired, the spray cap 52 remains in that set position until purposefully readjusted.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A cleaning apparatus for shoe soles, the apparatus comprising in combination: a resilient base mat having a waft material gripping surface; a top mat of a moisture absorbent terry fabric, the top mat laid over the waft material gripping surface of the base mat and mechanically engaged therewith; a reservoir containing a cleaning solution, the reservoir positioned at an edge of the base mat and the top mat; a foot actuated spray mechanism engaged with the reservoir, the spray mechanism positioned above and to one side of the top mat, the spray mechanism enabled for drawing the solution from the reservoir and distributing a fine mist of the solution onto only a first portion of the top mat; a second portion of the top mat positioned so as to remain free of the fine mist; whereby, to clean the shoe soles, the spray mechanism is foot actuated thereby delivering the fine mist to the first portion of the top mat, the shoe soles are then dragged on the first portion of the top mat to bring the solution into rubbing contact with the shoe soles and the shoe soles are then dragged on the second portion of the top mat to dry the shoe soles.

2. The apparatus of claim 1 wherein the reservoir and spray mechanism are jointly a pressurized spray can.

3. The apparatus of claim 1 wherein the reservoir is a container providing an aperture for accepting the cleaning solution therein and the spray mechanism is a pressure actuated pump.

4. The apparatus of claim 1 wherein the cleaning solution is one of: water, an aqueous solution containing ammonia, an aqueous solution containing an acid, an aqueous solution containing a soap, and a glass cleaning solution.

5. The apparatus of claim 2 further comprising a stand providing a cradle, a hinged foot pedal, and a base plate, the base plate engaging the cradle and the foot pedal thereon; the base plate extensive for resting below the base mat when the cradle and the foot pedal are adjacent the edge of the base mat.

6. The apparatus of claim 5 wherein the cradle is set at an angle capable of supporting the pressurized spray at the angle by only gravitational force.

7. The apparatus of claim 5 wherein the foot pedal provides a cap receiver sized for frictionally gripping a spray cap of the spray mechanism.

8. A method of cleaning shoe soles, the method comprising the steps of:
a) placing a resilient base mat having a waft material gripping surface on a supporting surface;
b) placing a top mat of a moisture absorbent terry fabric over the base mat so as to engage the waft material gripping surface of the base mat;
c) placing a reservoir containing a cleaning solution at an edge of the base mat and the top mat;
d) engaging a foot actuated spray mechanism with the reservoir such that the spray mechanism is positioned above and to one side of the top mat;
e) enabling the spray mechanism for drawing the solution from the reservoir and disbursing a fine mist, positioning a first portion of the top mat for receiving the mist and positioning a second portion of the top mat so as to not receive the fine mist;
f) actuating the spray mechanism by foot thereby delivering the fine mist to the first portion of the top mat;
g) dragging the shoe soles on the first portion of the top mat to bring the solution into rubbing contact with the shoe soles thereby removing and dissolving debris from the soles;
h) dragging the shoe soles on the second portion of the top mat to dry the shoe soles.

9. The method of claim 8 further comprising the step of frictionally gripping a spray cap of the spray mechanism with a cap receiver of the foot pedal thereby preventing the spray cap from rotating.
